(19) United States
(12) Patent Application Publication
(10) Pub. No.: US 2025/0354437 A1
(43) Pub. Date: Nov. 20, 2025

(54) GARAGE DOOR SCREEN WITH SWINGING DOOR

(71) Applicant: Michael Edward Hoenig, Highlands Ranch, CO (US)

(72) Inventor: Michael Edward Hoenig, Highlands Ranch, CO (US)

(21) Appl. No.: 18/665,502

(22) Filed: May 15, 2024

(51) Int. Cl. E06B 9/52; E05F 15/684

(52) U.S. Cl. CPC E06B 9/52; E05F 15/684; E05Y 2900/106; E05Y 2900/136

(57) ABSTRACT

A garage door screen with a swinging door is disclosed. A durable multi-panel full garage door screen with a built in swinging door transforms a garage into a fully functioning indoor/outdoor space which allows airflow and protection from pests and provides easy ingress and egress to and from the interior of the garage. The garage door screen with swinging door operates just like a regular garage door. There are three or four or more horizontal panels depending upon the height of the garage door opening that are hinged together just like a regular garage door but the panels are screened and not solid wood or windows.

### BACKGROUND

Field of the Invention—This invention relates to garage door screens.

### SUMMARY

This Summary is provided to introduce in a simplified form a selection of concepts that are further described below in the Detailed Description. This Summary is not intended to identify key or essential features of the claimed subject matter, nor is it intended to be used to limit the scope of the claimed subject matter.

The detailed description below describes a garage door screen with a built in swinging door.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together. When each one of A, B, and C in the above expressions refers to an element, such as X, Y, and Z, or class of elements, such as X1-Xm, Y1-Yn, and Z1-Zo, the phrase is intended to refer to a single element selected from X, Y, and Z, a combination of elements selected from the same class (e.g., X1 and X2) as well as a combination of elements selected from two or more classes (e.g., Y1 and Z3).

It is to be noted that the term “a entity” or “an entity” refers to one or more of that entity. As such, the terms “a” (or “an”), “one or more,” and “at least one” can be used interchangeably herein. It is also to be noted that the terms “comprising.” “including,” and “having” can be used interchangeably.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all the equivalents thereof. Further, the structures, materials or acts and the equivalents thereof shall include all those described in the summary of the invention, brief description of the drawings, detailed description, abstract, and claims themselves.

There are many types of garage door screens. Some are simply giant screens that roll up and down like a window shade but have no opening. Ingress and egress to the garage requires opening the entire screen. Some garage door screens are one solid piece with a doorway built in. The tracks are parallel to each other along the ceiling and the vertical wall and require a lot of clearance inside the garage due to the physical space that the garage door screen must travel through from the closed position to the open position.

The garage door screen with swinging door is a durable multi-panel full garage door screen with a built in swinging door that transforms the garage into a fully functioning indoor/outdoor space which allows airflow and protection from pests and provides easy ingress and egress to and from the interior of the garage. The garage door screen with swinging door operates just like a regular garage door. There are three or four or more horizontal panels depending upon the height of the garage door opening that are hinged together just like a regular garage door but the panels are screened and not solid wood or windows.

### BRIEF DESCRIPTION OF THE SEVERAL VIEWS OF THE DRAWINGS

FIG. 1 shows a perspective view of a garage door and a garage door screen with swinging door in the open position in an embodiment of the invention.

FIG. 2 shows a perspective view of the garage door in the open position and the garage door screen with swinging door in the closed position in an embodiment of the invention.

FIG. 3 shows a perspective view and a partial cut-away view of the garage door and the garage door screen with swinging door in the closed position in an embodiment of the invention.

FIG. 4 shows a perspective view of the garage door and the garage door screen with swinging door in the closed position with dual motors instead of one motor in an embodiment of the invention.

FIG. 5 shows an elevation view from inside the garage of a three-panel garage door screen in the closed position with a two-panel swinging door in an embodiment of the invention.

FIG. 6 shows an elevation view from inside the garage of a four-panel garage door screen in the closed position with a three-panel swinging door in an embodiment of the invention.

FIG. 7 shows an enlarged view of the two-panel swinging door from FIG. 5 in an embodiment of the invention.

To assist in the understanding of the present disclosure the following list of components and associated numbering found in the drawings is provided herein:

Table of Components

| Component | # |
|---|---|
| garage door | 2 |
| horizontal panel | 3 |
| rails | 4 |
| motor | 6 |
| drive chain | 8 |
| garage door screen | 10 |
| garage door screen | 10′ |
| rails | 12 |
| drive chain | 14 |
| motor | 16 |
| drive chain | 18 |
| lower horizontal panel | 20a |
| middle horizontal panel | 20b |
| upper horizontal panel | 20c |
| lower horizontal panel | 20a′ |
| lower middle horizontal panel | 20b′ |
| upper middle horizontal panel | 20c′ |
| upper horizontal panel | 20d |
| two-panel swinging door | 22 |
| three-panel swinging door | 22′ |
| first rigid frame | 24 |
| second rigid frame | 24′ |
| first hinge | 26 |
| second hinge | 26′ |
| first hinge side rigid frame | 28 |
| second hinge side rigid frame | 28′ |
| horizontal panel hinge | 29 |
| horizontal panel hinge | 29′ |
| magnetic strip | 30 |
| magnetic strip | 32 |
| magnetic strip | 34 |
| magnetic strip | 36 |
| handle | 38 |
| handle | 38′ |
| magnetic strip | 40 |
| magnetic strip | 42 |
| magnetic strip | 44 |
| first handle side rigid frame | 46 |
| second handle side rigid frame | 46′ |
| magnetic strip | 48 |
| second handle side rigid frame | 50 |

### DETAILED DESCRIPTION

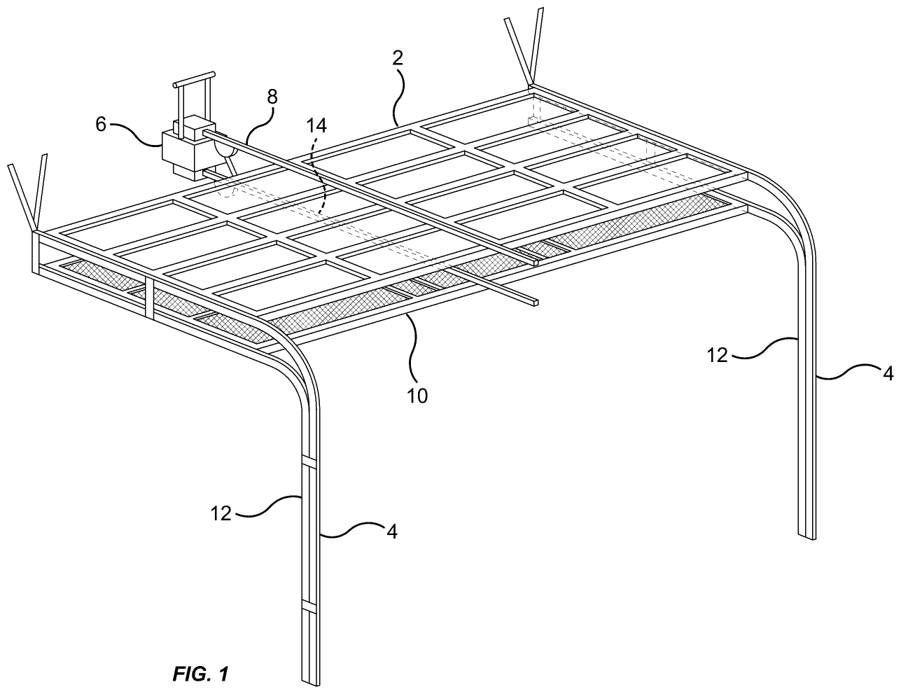

Referring now to the Figures, like reference numerals and names refer to structurally and/or functionally similar elements thereof, and if objects depicted in the figures that are covered by another object, as well as the tag line for the element number thereto, may be shown in dashed lines. FIG. 1 shows a perspective view of a garage door and a garage door screen with swinging door in the open position in an embodiment of the invention. Referring now to FIG. 1, garage door 2 is a typical multi-panel garage door that runs on a pair of parallel rails 4 and is opened and closed via motor 6 and drive chain 8. Garage door screen 10 runs on two parallel rails 12 that are located just below and behind the rails 4 of garage door 2 and is also opened and closed via motor 6 and drive chain 14.

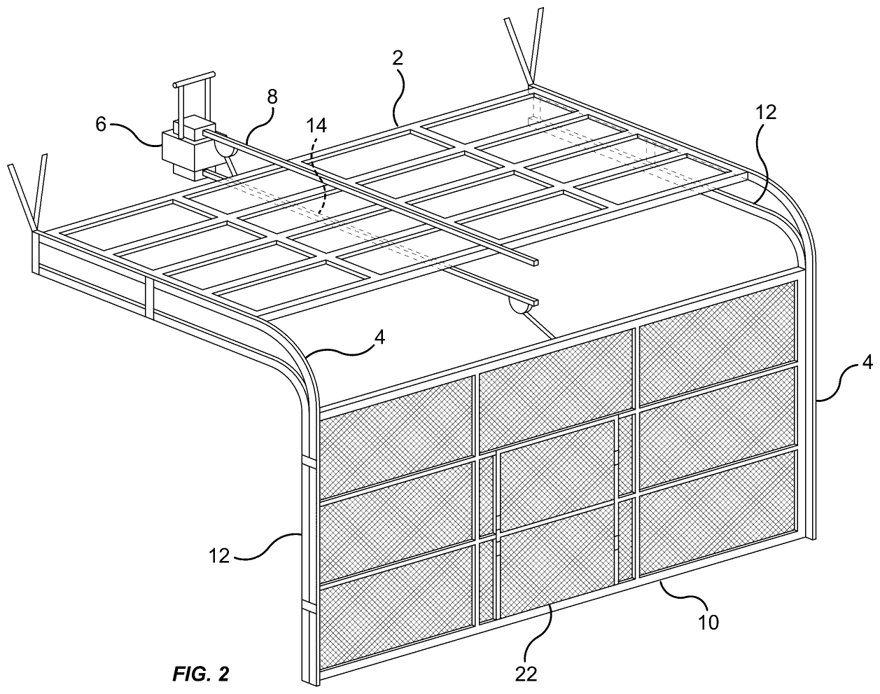

FIG. 2 shows a perspective view of the garage door in the open position and the garage door screen with swinging door in the closed position in an embodiment of the invention. Referring now to FIG. 2, motor 6 and drive chain 14 have closed garage door screen 10 while garage door 2 is in the open position.

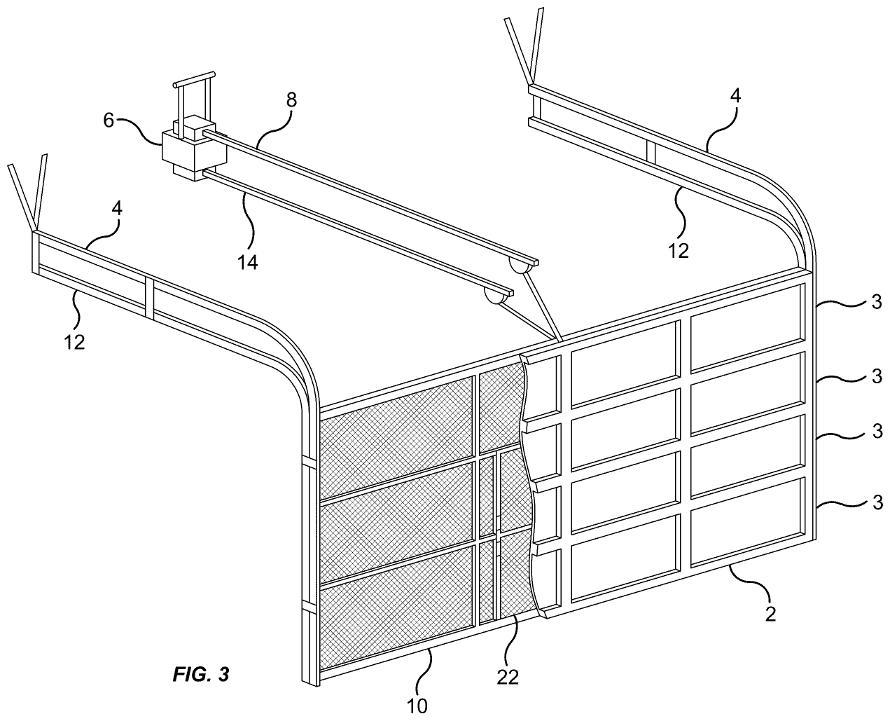

FIG. 3 shows a perspective view and a partial cut-away view of the garage door and the garage door screen with swinging door in the closed position in an embodiment of the invention. Referring now to FIG. 3, motor 6 and drive chain 8 have now closed garage door 2 which has a plurality of horizontal panels 3.

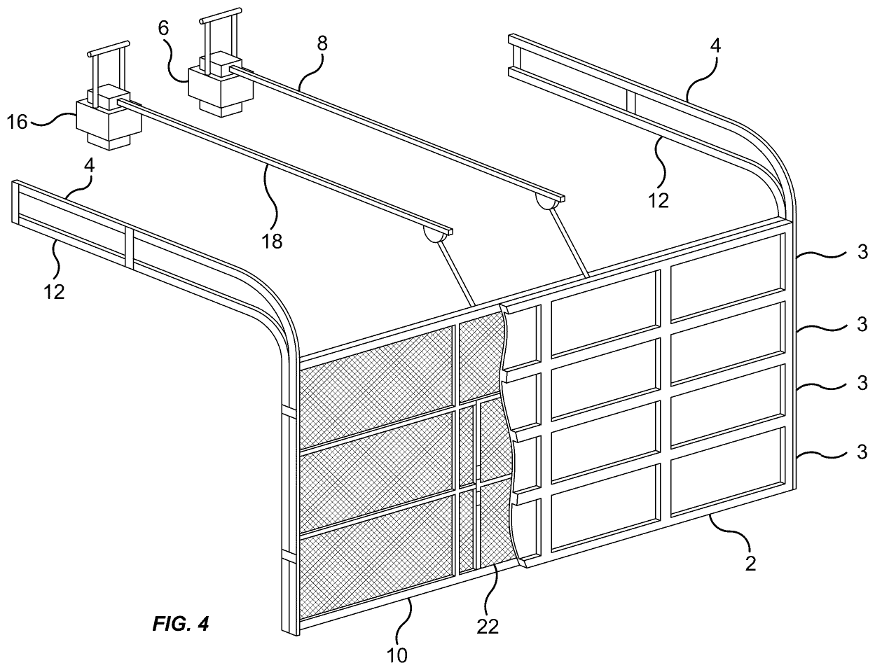

FIG. 4 shows a perspective view of the garage door and the garage door screen with swinging door in the closed position with dual motors instead of one motor in an embodiment of the invention. Referring now to FIG. 4, motor 16 and drive chain 18 open and close garage door screen 10 while motor 6 and drive chain 8 open and close garage door 2.

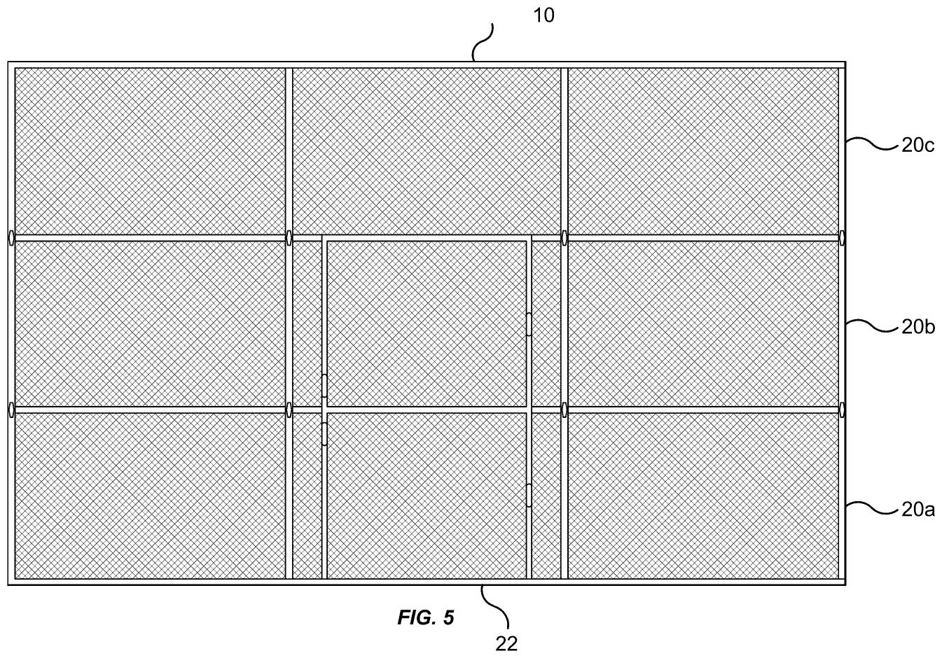

FIG. 5 shows an elevation view from inside the garage of a three-panel garage door screen in the closed position with a two-panel swinging door in an embodiment of the invention. Referring now to FIG. 5, garage door screen 10 has three horizontal panels 20a, 20b, and 20c and a two-panel swinging door 22 that extends vertically across the two horizontal panels 20a and 20b. Two-panel swinging door 22 is shown in the middle section of the garage door screen 10, but it also could be located in the left section or the right section of the garage door screen 10.

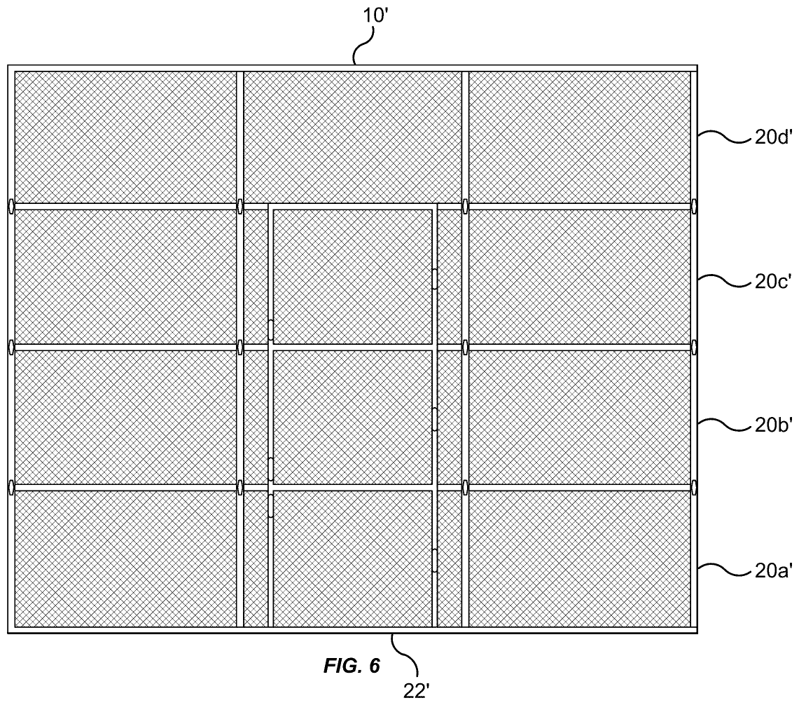

FIG. 6 shows an elevation view from inside the garage of a four-panel garage door screen in the closed position with a three-panel swinging door in an embodiment of the invention. Referring now to FIG. 6, garage door screen 10′ has lower horizontal panel 20a′, lower middle horizontal panel 20b′, upper middle horizontal panel 20c′, and upper horizontal panel 20d′ and a three-panel swinging door 22′ that extends vertically across the lower horizontal panel 20a′, lower middle horizontal panel 20b′, and upper middle horizontal panel 20c′. Three-panel swinging door 22′ is shown in the middle section of the garage door screen 10′, but it also could be located in the left section or the right section of the garage door screen 10′.

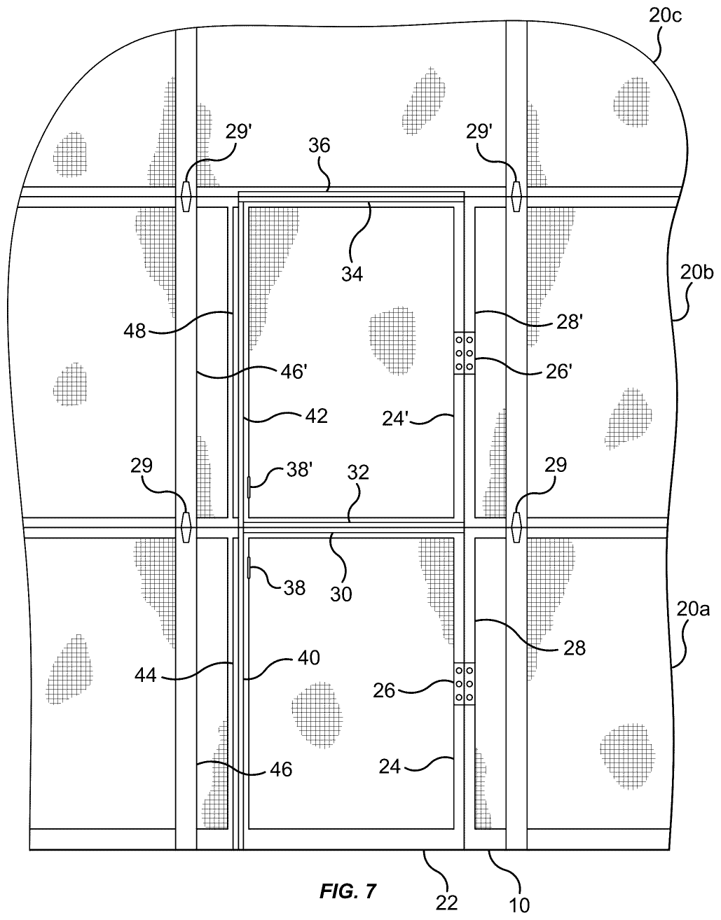

FIG. 7 shows an enlarged view of the two-panel swinging door from FIG. 5 in an embodiment of the invention. Referring now to FIG. 7, garage door screen 10 is comprised of a lower horizontal panel 20a, a middle horizontal panel 20b located just above lower horizontal panel 20a, and an upper horizontal panel 20c located just above middle horizontal panel 20b. All three horizontal panels 20a/20b/20c span the width of the garage door screen 10. Lower horizontal panel 20a and middle horizontal panel 20b are connected together via horizontal panel hinges 29, and middle horizontal panel 20b and upper horizontal panel 20c are connected together via horizontal panel hinges 29′ allowing the horizontal panels 20a/20b/20c to move from a parallel plane with respect to each other to being at an angle with respect to each other as garage door screen 10 is moved from a closed to an open position.

The two-panel swinging door 22 has a first rigid frame 24 having four sides—top, right, bottom, and left—located in the lower horizontal panel 20a. The two-panel swinging door 22 has a second rigid frame 24′ having four sides—top, right, bottom, and left—located in the middle horizontal panel 20b. On the right side of first rigid frame 24 is a first hinge 26. On the right side of first rigid frame 24′ is a second hinge 26′. The first hinge 26 connects the first rigid frame 24 to the first hinge side rigid frame 28. The second hinge 26′ connects the second rigid frame 24′ to the second hinge side rigid frame 28′. The first hinge 26 enables the first rigid frame 24 to swing open from the first hinge side rigid frame 28. The second hinge 26′ enables the second rigid frame 24′ to swing open from the second hinge side rigid frame 28′.

A magnetic strip 30 is fixedly attached to the top side of first rigid frame 24. The term “fixedly attached” may mean glued, nailed, screwed, or any other suitable permanent attachment mechanism. A magnetic strip 32 is fixedly attached to the bottom side of second rigid frame 24′. Magnetic strip 30 and magnetic stirp 32 attract each other so that when first rigid frame 24 and second rigid frame 24′ are swung open, they move together in unison. A magnetic strip 34 is fixedly attached to the top side of second rigid frame 24′. A magnetic strip 36 is fixedly attached to the bottom side of a section of upper horizontal panel 20c. When first rigid frame 24 and second rigid frame 24′ are swung open, magnetic strip 34 and magnetic strip 36 break away from each other.

As the horizontal panels 20a/20b are moved from a parallel plane with respect to each other to being at an angle with respect to each other as garage door screen 10 is moved from a closed to an open position, magnetic strips 30 and 32 will separate from each other. Similarly, as the horizontal panels 20b/20c are moved from a parallel plane with respect to each other to being at an angle with respect to each other as garage door screen 10 is moved from a closed to an open position, magnetic strips 34 and 36 will separate from each other.

First rigid frame 24 has a handle 38 near the top on the left side of first rigid frame 24. Second rigid frame 24′ has a handle 38′ near the bottom on the left side of second rigid frame 24′. When garage screen door 10 is in the closed position, handles 38/38′ can be grasped to swing open the first rigid frame 24 and the second rigid frame 24′ about hinges 26/26′. Magnetic strips 30/32 keep the first rigid frame 24 and the second rigid frame 24′ together as both are swung open. Magnetic strips 34 and 36 will separate as second rigid frame 24′ is swung open.

A magnetic strip 40 is fixedly attached to the left side of first rigid frame 24. A magnetic strip 42 is fixedly attached to the left side of second rigid frame 24′. A magnetic strip 44 is fixedly attached to a first handle side rigid frame 46. A magnetic strip 48 is fixedly attached to a second handle side rigid frame 46′. When first rigid frame 24 and second rigid frame 24′ are swung open, magnetic strip 40 and magnetic strip 44 will separate from each other. Similarly, when first rigid frame 24 and second rigid frame 24′ are swung open, magnetic strip 42 and magnetic strip 48 will separate from each other.

When garage screen door 10 is in the closed position, handles 38/38′ can be grasped to swing open the first rigid frame 24 and the second rigid frame 24′ about hinges 26/26′. Magnetic strips 40 and 44, and 42 and 48, separate from each other, allowing first rigid frame 24 and the second rigid frame 24′ to rotate about hinges 26/26′ to create an opening allowing ingress and egress through garage door screen 10 when it is in the closed position. One skilled in the art will recognize that for the three panel swinging door 22′, a third rigid frame will be positioned above second rigid frame 24′ having a third hinge, a third handle, and the same arrangement of magnetic strips between the third rigid frame, the third hinge side rigid frame, and the third handle side rigid frame. This same pattern can be repeated for a four panel swinging door (not shown).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. A garage door screen with a swinging door comprising:
a lower horizontal panel;
a middle horizontal panel;
an upper horizontal panel;
a first four-sided rigid frame located in the lower horizontal panel, the first four-sided rigid frame further comprising:
a first hinge swingably connecting a first vertical side of the first four-sided rigid frame to a first hinge side rigid frame of the lower horizontal panel;
a first magnetic strip fixedly attached to a top side of first rigid frame; and
a second magnetic strip fixedly attached to a second vertical side of the first four-sided rigid frame;
a second four-sided rigid frame located in the middle horizontal panel, the second four-sided rigid frame further comprising:
a second hinge swingably connecting a first vertical side of the second four-sided rigid frame to a first hinge side rigid frame of the middle horizontal panel;
a first magnetic strip fixedly attached to a top side of second rigid frame;
a second magnetic strip fixedly attached to a second vertical side of the second four-sided rigid frame; and
a third magnetic strip fixedly attached to a bottom side of second rigid frame;
a magnetic strip fixedly attached to a first handle side rigid frame of the lower horizontal panel;
a magnetic strip fixedly attached to a first handle side rigid frame of the middle horizontal panel; and
a magnetic strip fixedly attached to a bottom side of upper horizonal panel opposite of a top side of the second four-sided rigid frame.

2. The apparatus according to claim 1 further comprising:
a first handle located on the second vertical side of the first four-sided rigid frame; and
a second handle located on the second vertical side of the second four-sided rigid frame.

3. The apparatus according to claim 1 further comprising:
a plurality of horizontal panel hinges that connect the lower horizontal panel to the middle horizontal panel allowing the lower horizontal panel and the middle horizontal panel to move from a parallel plane with respect to each other to being at an angle with respect to each other as garage door screen is moved from a closed to an open position.

4. The apparatus according to claim 1 further comprising:
a plurality of horizontal panel hinges that connect the middle horizontal panel to the upper horizontal panel allowing the middle horizontal panel and the upper horizontal panel to move from a parallel plane with respect to each other to being at an angle with respect to each other as garage door screen is moved from a closed to an open position.

5. The apparatus according to claim 1 further comprising:
a first pair of parallel rails that engage with each end of the lower horizontal panel, each end of the middle horizontal panel, and each end of the upper horizontal panel as the garage door screen is moved from a closed to an open position.

6. The apparatus according to claim 1 further comprising:
a motor; and
a drive chain, wherein the motor drives the drive chain to move the garage door screen from a closed to an open position.

7. The apparatus according to claim 6 further comprising:
a garage door having a plurality of horizontal panels;
a second pair of parallel rails that engage with each end of the plurality of horizontal panels, the second pair of parallel rails are located just above and in front of the first pair of parallel rails; and
a drive chain, wherein the motor drives the drive chain to move the garage door from a closed to an open position.

8. The apparatus according to claim 6 further comprising:
a second motor in place of first motor, and a second drive chain in place of drive chain, wherein second motor drives the drive chain to move the garage door screen from a closed to an open position.

9. A garage door screen with a swinging door comprising:
a lower horizontal panel;
a lower middle horizontal panel;
an upper middle horizontal panel;
an upper horizontal panel;
a first four-sided rigid frame located in the lower horizontal panel, the first four-sided rigid frame further comprising:
a first hinge swingably connecting a first vertical side of the first four-sided rigid frame to a first hinge side rigid frame of the lower horizontal panel;
a first magnetic strip fixedly attached to a top side of first rigid frame; and
a second magnetic strip fixedly attached to a second vertical side of the first four-sided rigid frame;
a second four-sided rigid frame located in the lower middle horizontal panel, the second four-sided rigid frame further comprising:
a second hinge swingably connecting a first vertical side of the second four-sided rigid frame to a first hinge side rigid frame of the lower middle horizontal panel;
a first magnetic strip fixedly attached to a top side of second rigid frame;
a second magnetic strip fixedly attached to a second vertical side of the second four-sided rigid frame; and
a third magnetic strip fixedly attached to a bottom side of second rigid frame;
a third four-sided rigid frame located in the upper middle horizontal panel, the third four-sided rigid frame further comprising:
a third hinge swingably connecting a first vertical side of the third four-sided rigid frame to a first hinge side rigid frame of the upper middle horizontal panel;
a first magnetic strip fixedly attached to a top side of third rigid frame;
a second magnetic strip fixedly attached to a second vertical side of the third four-sided rigid frame; and
a third magnetic strip fixedly attached to a bottom side of third rigid frame;
a magnetic strip fixedly attached to a first handle side rigid frame of the lower horizontal panel;
a magnetic strip fixedly attached to a first handle side rigid frame of the lower middle horizontal panel;
a magnetic strip fixedly attached to a first handle side rigid frame of the upper middle horizontal panel; and
a magnetic strip fixedly attached to a bottom side of upper horizonal panel opposite of a top side of the third four-sided rigid frame.

10. The apparatus according to claim 1 further comprising:
a first handle located on the second vertical side of the first four-sided rigid frame;
a second handle located on the second vertical side of the second four-sided rigid frame; and
a third handle located on the second vertical side of the third four-sided rigid frame.

11. The apparatus according to claim 9 further comprising:
a plurality of horizontal panel hinges that connect the lower horizontal panel to the lower middle horizontal panel allowing the lower horizontal panel and the middle horizontal panel to move from a parallel plane with respect to each other to being at an angle with respect to each other as garage door screen is moved from a closed to an open position.

12. The apparatus according to claim 9 further comprising:
a plurality of horizontal panel hinges that connect the lower middle horizontal panel to the upper middle horizontal panel allowing the lower middle horizontal panel and the upper middle horizontal panel to move from a parallel plane with respect to each other to being at an angle with respect to each other as garage door screen is moved from a closed to an open position.

13. The apparatus according to claim 9 further comprising:
a plurality of horizontal panel hinges that connect the upper middle horizontal panel to the upper horizontal panel allowing the upper middle horizontal panel and the upper middle horizontal panel to move from a parallel plane with respect to each other to being at an angle with respect to each other as garage door screen is moved from a closed to an open position.

14. The apparatus according to claim 9 further comprising:
a first pair of parallel rails that engage with each end of the lower horizontal panel, each end of the lower middle horizontal panel, each end of the upper middle horizontal panel, and each end of the upper horizontal panel as the garage door screen is moved from a closed to an open position.

15. The apparatus according to claim 9 further comprising:
a motor; and
a drive chain, wherein the motor drives the drive chain to move the garage door screen from a closed to an open position.

16. The apparatus according to claim 15 further comprising:
a garage door having a plurality of horizontal panels;
a second pair of parallel rails that engage with each end of the plurality of horizontal panels, the second pair of parallel rails are located just above and in front of the first pair of parallel rails; and
a drive chain, wherein the motor drives the drive chain to move the garage door from a closed to an open position.

17. The apparatus according to claim 15 further comprising:
a second motor in place of first motor, and a second drive chain in place of drive chain, wherein second motor drives the drive chain to move the garage door screen from a closed to an open position.
